(19) United States
(12) Patent Application Publication
(10) Pub. No.: US 2006/0069866 A1
(43) Pub. Date: Mar. 30, 2006

(54) Disk array apparatus, disk array control method and computer program product therefor

(75) Inventor: Manabu Miyazaki, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Corporation, Tokyo (JP)

(21) Appl. No.: 11/230,534

(22) Filed: Sep. 21, 2005

(30) Foreign Application Priority Data
Sep. 22, 2004 (JP) 274469/2004

(51) Int. Cl. G06F 12/14

(52) U.S. Cl. 711/114

(57) ABSTRACT

A disk array apparatus including a plurality of physical disks, includes: a response time measuring unit measuring a response time to an access to the physical disk; and a performance deterioration judging unit judging performance deterioration of a specific physical disk of the plurality of physical disks, on the basis of the response time of the physical disks and the response time of the specific physical disk.

### BACKGROUND OF THE INVENTION

1. Field of the Invention

The present invention relates to a disk array apparatus, a disk array control method, and a computer program product therefor, and more particularly to a disk array apparatus, a disk array control method, and a computer program product therefor, which are capable of detecting a disk deteriorated in performance.

2. Description of the Related Art

In recent years, as can be seen in on-demand video delivery services, the need for accessing large amounts of data stored in a storage device without delay has increased. In the online transaction processing, although the need is not so large as the video delivery services, requirements for processing performance of a storage device have also become severe in accordance with improvement in performance of a server. To meet such requirements, a disk array apparatus in which a RAID (Redundant Arrays of Independent Disks) is used, and of which processing performance is improved by performing access to a plurality of disks in parallel, draws much attention and is widely used. In the RAID, various types are studied. Among major functions of the RAID, the first is to reduce the loss probability of data by providing the data with redundancy, and the second is to improve the performance by making the plurality of disks accessed in parallel.

In the conventional disk array apparatus, an importance is placed on the holding of data. In the conventional disk array apparatus, a faulty disk is determined by detecting a certain error event issued by the disk, and then exchanged. For example, in Japanese Patent Laid-Open No. 11-345095, there is disclosed a technique in which the disk is automatically exchanged in accordance with error occurrence frequency of the disk array apparatus.

However, in the disk array apparatus, even though an error event is not detected, the performance deterioration can occur, and hence it is necessary to quickly detect the deterioration of performance. As such a technique, there is disclosed in Japanese Patent Laid-Open No. 4-305865, a method in which a response time of a disk is detected and compared with a reference value, so as to enable the performance deterioration to be detected. There is also a known method in which after performance deterioration is detected, a part of blocks which is judged as a block failure is exchanged for a spare block.

However, the above described conventional disk array apparatuses have following problems. A first problem is that performance deterioration is judged by comparing a response time to input/output (hereinafter, referred to as “I/O”) request for a physical disk with a reference value, but the absolute value of the response time by which the deterioration is judged, is changed by various conditions, such as the type of disk, the size of I/O request data, and the load condition. Thus, the reference value is not easy to be set. That is, there is a problem that even if the reference value is set, it is difficult to accurately judge whether the performance deterioration has occurred.

The second problem is that when the performance deterioration occurs due to a cause other than a block failure, the performance deterioration can not be improved. The performance deterioration in the disk array apparatus occurs in an extremely large scale online transaction processing environment, and occurs steadily at random access. As a result, a performance deterioration phenomenon which cannot be explained by a failure of a part of the blocks, may occur.

### SUMMARY OF THE INVENTION

An exemplary feature of the present invention is to provide a disk array apparatus, a disk array controlling method, and a computer program product therefor, which are capable of accurately detecting the performance deterioration of a physical disk, and of preventing the occurrence of failures.

According to an example of the present invention, a disk array apparatus including a plurality of physical disks, includes:

a response time measuring unit measuring a response time to an access to the physical disk; and

a performance deterioration judging unit judging performance deterioration of a specific physical disk of the plurality of physical disks, on the basis of the response time of the physical disks and the response time of the specific physical disk.

According to another example of the present invention, a disk array control method including a plurality of physical disks, includes:

measuring a response time to an access to the physical disk; and

judging performance deterioration of a specific physical disk of the plurality of physical disks on the basis of the response time of the physical disks and the response time of the specific physical disk.

According to additional example of the present invention, a signal-bearing medium tangibly embodying a program of machine-readable instructions executable by a digital processing apparatus that permits a computer to function as:

a response time measuring unit measuring a response time to an access to a plurality of physical disks included in a disk array apparatus; and

a performance deterioration judging unit judging performance deterioration of a specific physical disk of the plurality of physical disks on the basis of the response time of the physical disks and the response time of the specific physical disk.

Exemplary advantage of the present invention is that performance deterioration of a physical disk constituting a disk array apparatus can be accurately detected.

### BRIEF DESCRIPTION OF THE DRAWINGS

The above and other objects, features and advantages of the present invention will become apparent from the following detailed description when taken with the accompanying drawings in which:

FIG. 1 is a block diagram showing a configuration of an embodiment according to the present invention;

FIG. 2 is a block diagram showing a configuration of a processing unit according to the present invention;

FIG. 3 is a flow chart showing an operation in performance deterioration judgment, according to the present invention; and

FIG. 4 is a flow chart showing an operation in physical disk exchange according to the present invention.

### DETAILED DESCRIPTION OF THE EXEMPLARY EMBODIMENT

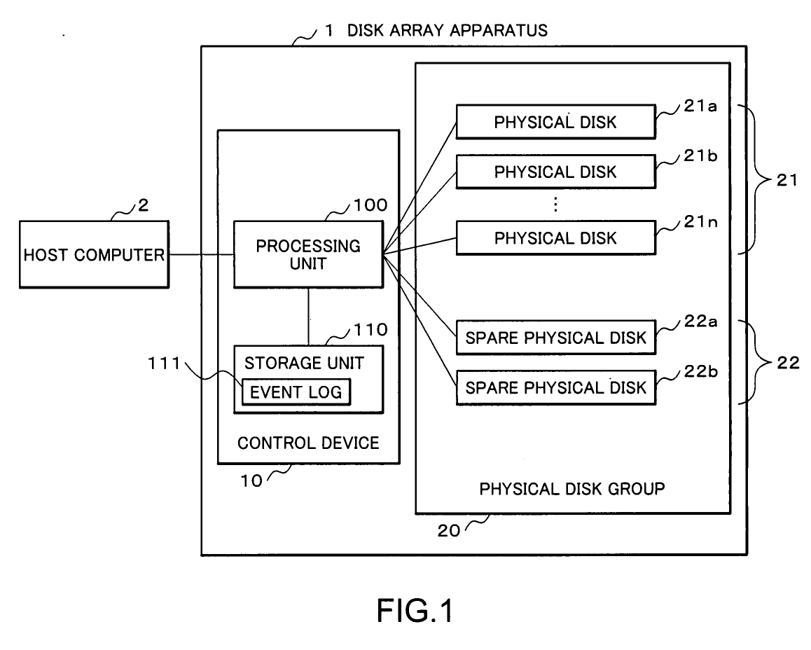

FIG. 1 is a block diagram showing a configuration of an embodiment according to the present invention. A disk array apparatus 1 according to the present invention is connected with a host computer 2 performing I/O requests. The disk array apparatus 1 includes a control device 10 and a physical disk group 20 constituted by a plurality of physical disks. The control device 10 receives an I/O request from the host computer 2 to perform I/O control of the physical disk.

The physical disk group 20 includes physical disks 21 (21a, 21b, . . . , 21n) and spare physical disks 22 (22a, 22b). The physical disks 21 are used in a RAID constitution, and are actually accessed. The spare physical disks 22 are not used in the RAID constitution, but are spares for exchange upon the occurrence of a failure. The mounting numbers of the physical disks 21 and the spare physical disks 22 are not limited to the illustrated numbers.

The control device 10 includes a processing unit 100 and a storage unit 110. The storage unit 110 stores an event log 111 in which events are recorded.

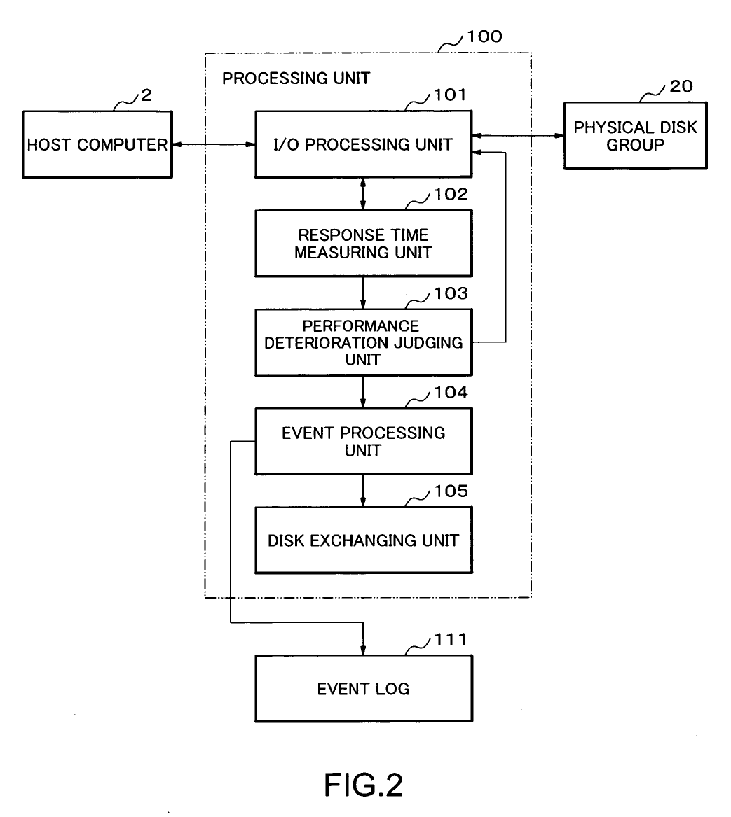

FIG. 2 is a block diagram showing a configuration of the processing unit 100 according to the present invention. The processing unit 100 includes an I/O processing unit 101, a response time measuring unit 102, a performance deterioration judging unit 103, an event processing unit 104, and a disk exchanging unit 105.

The I/O processing unit 101 accesses the physical disk 21 constituting the RAID in accordance with an instruction from the host computer 2, so as to perform recording and reproducing processing of data. In the case where the I/O process unit 101 accesses the physical disk 21, the I/O processing unit 101 notifies the response time measuring unit 102 of the start of access to the physical disks 21 at the time of starting the access, and also notifies the response time measuring unit 102 of the receipt of a response from the physical disk 21 at the time of receiving the response. Similarly to a common I/O processing unit, the I/O processing unit 101 notifies the host computer 2 of results of recording and reproducing processing of data of the physical disk 21.

The response time measuring unit 102 measures a response time of the physical disk 21 in accordance with the notification from the I/O processing unit 101. In this way, a response time to an access to the physical disk 21 can be measured by the I/O processing unit 101 and the response time measuring unit 102. The response time measuring unit 102 notifies the performance deterioration judging unit 103 of the measured response time.

The performance deterioration judging unit 103 calculates an average value Ta of the measured response time of the physical disks 21. Here, it is assumed that the average of the response time of all the physical disks 21 constituting the RAID is calculated. Then, the performance deterioration judging unit 103 specifies each of the physical disks (for example, physical disk 21a) as a specific physical disk, and calculates a ratio (T/Ta) (hereinafter referred to as “deterioration ratio”) of the response time T of the specific physical disk to the above described average value Ta. The performance deterioration judging unit 103 compares the deterioration ratio (T/Ta) with a reference ratio preliminarily incorporated in the performance deterioration judging unit 103. In the case where the response time T of the specific physical disk 21a has a delay larger than the average value Ta at this time, the value of the calculated deterioration ratio (T/Ta) becomes larger than 1, and as the delay becomes large, the value of the deterioration ratio becomes large. Accordingly, a value which serves as the reference ratio, and which enables the performance deterioration to be judged, is obtained in advance by means of a theoretical formula or an experiment.

The performance deterioration judging unit 103 judges that performance of the specific physical disk 21a selected as a present target is deteriorated, when the calculated deterioration ratio (T/Ta) is larger than the reference ratio (or when the calculated deterioration ratio is equal to the reference ratio). Then, the performance deterioration judging unit 103 successively changes the specific physical disk to be targeted to another physical disk (for example, physical disk 21b), and repeats the above described judging processing of performance deterioration for all the physical disks 21. That is, the performance deterioration judging unit 103 obtains the deterioration ratio (T/Ta) of each of the physical disks 21, and compares the deterioration ratio with the reference ratio, thereby judging whether each of the physical disks 21 is deteriorated or not. Then, the performance deterioration judging unit 103 notifies the event processing unit 104 of the judgment result about each of the physical disks 21.

The reason why the method of comparing the response time of a specific physical disk with those of other physical disks constituting the same RAID is adopted in the present invention as described above, is as follows. The physical disks constituting the same RAID, in which the same kind of physical disk is used, and in which the size and load condition of I/O data are also the same because the RAID is constituted by the same stripe size, are suitable as the comparison object. Also, it is known from experiments that even between normal physical disks, the maximum response time and the minimum response time of each of the physical disks may be different to an extent of about 1.5 times, depending upon the load characteristic. Thus, in order to improve the accuracy of judgment, the response time of a specific physical disk is compared with the average value of the response time of physical disks used in the same RAID. The experiments have shown the fact that the response time of a normal physical disk is not longer by two times or more than the average value, and hence the fact is taken as a basis for judging the performance deterioration. That is, the value of the above described reference ratio is set to “2”, and when the deterioration ratio is larger than this value, the performance is judged to be deteriorated. However, the value of the reference ratio is not limited to this value.

The performance deterioration judging processing performed by the performance deterioration judging unit 103 is not limited to the above described method. For example, the average value Ta of the response time may not be the average value of all the physical disks 21, but may be an average value of the other physical disks except the specific physical disk on which the deterioration judgment is performed. That is, in the case where deterioration of the physical disk 21a is judged, the average value Ta of the other physical disks 21b, . . . , 21n may be calculated, so that the ratio of the response time T of the physical disk 21a to Ta is taken as the deterioration ratio. Further, the performance deterioration judgment is not limited to the above described method for calculating the deterioration ratio, but other arithmetic operations may also be used. For example, the response time of the specific physical disk 21 may be compared with an average value of the response time of a plurality of arbitrary physical disks 21. In some designs of RAID, the connection route of a physical disk 21 of an odd number may be different from that of a physical disk 21 of an even number. In this case, the performance comparison between physical disks 21 having more similar load conditions can be performed by selecting a plurality of arbitrary physical disks 21.

The event processing unit 104 records events of the physical disk of which performance is judged to be deteriorated, in the event log 111 in accordance with the notification from the performance deterioration judging unit 103. The event processing unit 104 also notifies the disk exchanging unit 105 of information about the above described events, i.e., information specifying the physical disk 21 of which performance is judged to be deteriorated, and the deterioration ratio (T/Ta) obtained at the judgment.

The disk exchanging unit 105 compares the notified deterioration ratio (T/Ta) with an exchange reference ratio set in advance. This exchange reference ratio is set to for example “3”, which is a far larger value than the above described reference ratio for making performance of a specific physical disk judged to be deteriorated, and which means that the response time of the specific physical disk is delayed by three times as long as the average value. In the case where the deterioration ratio is larger than the exchange reference ratio (or in the case where these ratios are equal to each other), the disk exchanging unit 105 performs exchange processing so as to enable the spare physical disk 22 to be used instead of the specific physical disk 21. For example, when the physical disk 21a constituting the RAID is judged to be exchanged as describe above, the disk exchanging unit 105 copies data stored in the physical disk 21a into the spare physical disk 22a, and exchanges the physical disk 21a for the spare physical disk 22a so as to make the spare physical disk 22a constitute the RAID. However, since the exchange processing is performed per a physical disk 21, it takes time to actually perform the exchange processing, as a result of which the timing for the exchange is set in the disk exchanging unit 105 by the user. For example, in the case where a task stopping period is set as the time zone available for the automatic exchange, the disk exchanging unit 105 performs the exchange processing of the physical disk 21a which is judged to be subjected to the exchange processing, in the timing set to the task stopping period. The user may also set the exchange period on the basis of other conditions.

As described above, an example in which the exchange processing is performed when the calculated deterioration ratio (T/Ta) become 3 times or more the average value, is described, but the exchange reference ratio is not limited to this value. In addition, the timing for the exchange may not be set in particular, and the disk exchanging unit 105 may also be set so as to perform the exchange processing of the physical disk 21, at the time when the physical disk is judged to be deteriorated in performance by the performance deterioration judging unit 103.

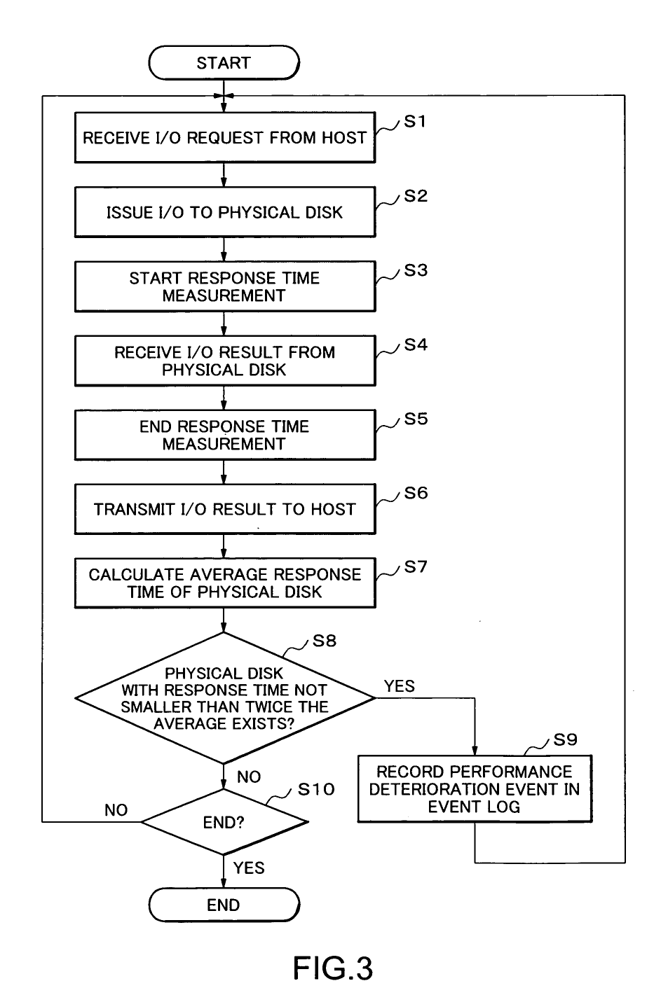

Next, the operation of the embodiment according to the present invention is explained. FIG. 3 is a flow chart showing an operation in performance deterioration judgment according to the present invention.

The I/O processing unit 101 of the processing unit 100, upon receipt of an I/O request from the host computer 2 (step S1), determines physical disks 21 to which I/Os are to be issued, among physical disks 21 constituting the RAID on the basis of the RAID information. The I/O processing unit 101 issues in parallel the I/Os to the determined physical disks 21 (step S2). The I/O processing unit 101 starts to measure the response time to the I/Os issued to the physical disks 21 constituting the RAID, in cooperation with the response time measuring unit 102 (step S3).

The I/O processing unit 101, upon receipt of I/O results from the physical disks 21 (step S4), terminates the measurement of the response time to the I/Os issued to the physical disks 21 constituting the RAID, in cooperation with the response time measuring unit 102 (step S5). The I/O processing unit 101 transmits the I/O results to the host computer 2 (step S6).

The response time measuring unit 102 notifies the performance deterioration judging unit 103 of the measured response time. The performance deterioration judging unit 103 calculates an average value of the response time of the physical disks 21 constituting the RAID (step S7), and obtains a ratio of the response time of each of the physical disks 21 constituting the RAID to the average value. The performance deterioration judging unit 103 judges whether a physical disk 21 with the deterioration ratio not smaller than 2 exists or not (step S8). When the judgment result is NO in step S8, the performance deterioration judging unit 103 judges that there is no physical disk 21 of which performance is deteriorated, and notifies the I/O processing sections 101 of the judgment result. If the I/O processing is not terminated at this time (in the case of negative judgment in step S10), the I/O processing unit 101 returns to step S1, and continues the I/O processing. When YES in step S8, i.e., a physical disks 21 with the deterioration ratio not smaller than 2 exists, the performance deterioration judging unit 103 judges that the physical disk 21 is deteriorated in response time performance, and notifies the event processing unit 104 of the judgment result. The notified event information includes information for specifying the physical disk 21 and the deterioration ratio. In the event processing unit 104, the notified event information is recorded in the event log 111, so as to be stored in the storage unit 110 (step S9).

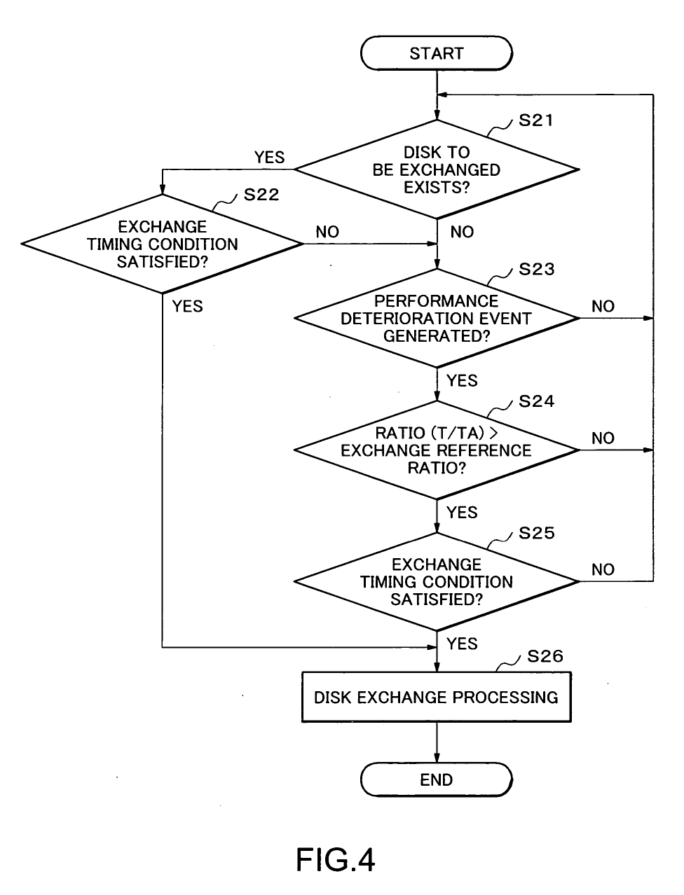

FIG. 4 is a flow chart showing an operation in physical disk exchange according to the present invention. The operation in the case where the processing unit 100 exchanges the physical disks, i.e., the operation which is performed by the disk exchanging unit 105 notified of the occurrence of event by the event processing unit 104, is explained with reference to FIG. 4.

The disk exchanging unit 105 of the processing unit 100 checks whether the physical disk 21 to be exchanged already exists, while waiting for notification of event in order to perform the exchange processing (step S21). Here, the physical disk 21 to be exchanged does not exist (NO in step S21).

When a performance deterioration event that the deterioration ratio (T/Ta) of a specific physical disk 21 is not smaller than 2, is generated, the disk exchanging unit 105 receives the notification of the event (YES in step S23). The disk exchanging unit 105 judges whether the physical disk 21 needs to be exchanged (step S24). The disk exchanging unit 105 compares the deterioration ratio (T/Ta) with the exchange reference ratio (for example “3”) set in advance by the user. The disk exchanging unit 105 returns to the event waiting state (steps S21, S23), when the deterioration ratio does not exceed the exchange reference ratio (NO in step S24). In the case where the deterioration ratio exceeds the exchange reference ratio (YES in Step S24), the disk exchanging unit 105 checks whether the exchange timing condition set by the user is satisfied (step S25). For example, in the case where a task stopping period is set in advance as the time zone available for automatic exchange, the disk exchanging unit 105 checks whether the present time is in the time zone.

When the exchange timing condition is satisfied (YES in step S25); the disk exchanging unit 105 performs the physical disk exchange processing (step S26). Specifically, the disk exchanging unit 105 copies data stored in the physical disk 21 judged to be exchanged into the spare physical disk 22, and exchanges the physical disk 21 for the spare physical disk 22 so as to make the spare physical disk 22 constitute the RAID. In the case where the exchange timing condition is not satisfied (NO in step. S25), for example, the present time is not in the task stopping period, the disk exchanging unit 105 returns to step S21, and repeats the above described processing. Even in the case where the performance deterioration event is not generated (NO in step S23), the disk exchanging unit 105 checks the event log 111 at fixed time intervals so as to judge whether a physical disk 21 to be exchanged exists (step S21). After returning to step S21 due to NO in step S25, in the case where the physical disk 21 to be exchanged exists (YES in step S21), the disk exchanging unit 105 monitors whether the exchange timing condition is satisfied (step S22). When the exchange timing condition is satisfied (YES in step S22), the disk exchanging unit 105 performs the disk exchange processing similarly to the case of YES in step S25 (step S26).

In the present invention, the performance deterioration of a specific physical disk is detected by comparing performance of the specific physical disk with performance of other physical disks. Therefore, the performance deterioration can be detected highly precisely, without depending upon the kind and the load condition of physical disks, unlike the prior art in which the performance deterioration is judged by the comparison with an absolute value. In particular, by adopting an average value of the response time as the comparison object, the performance deterioration judgment can be performed on the basis of comparison with a standard response time, as a result of which the performance deterioration judgment can be performed at a higher precision.

In addition, since a measure such as to perform the exchange of a physical disk before the occurrence of a fault in the physical disk, can be taken in accordance with the detection of performance deterioration, or since a physical disk of which performance is deteriorated can be automatically exchanged, it is possible to prevent in the disk array apparatus, disk failures which may occur due to all kinds of performance deterioration in association with the physical disks.

The operation of the processing unit 100 which is an embodiment according to the present invention, can be performed by the computer program processing. That is, the control device 10 reads a computer program recorded in a computer readable recording medium, or downloads the computer program from a network. Then, the control device 10 performs the computer program.

While the present invention has been described in connection with certain exemplary embodiments, it is to be understood that the subject matter encompassed by the present invention is not limited to those specific embodiments. On the contrary, it is intended to include all alternatives, modifications, and equivalents as can be included within the spirit and scope of the following claims.

Further, it is the inventor's intent to reform all equivalents of the claimed invention even if the claims are amended during prosecution.

What is claimed is:

1. A disk array apparatus including a plurality of physical disks, comprising:
a response time measuring unit measuring a response time to an access to said physical disk; and
a performance deterioration judging unit judging performance deterioration of a specific physical disk of said plurality of physical disks, on the basis of the response time of said physical disks and the response time of said specific physical disk.

2. The disk array apparatus according to claim 1,
wherein said performance deterioration judging unit judges performance deterioration of said specific physical disk by calculating an average value of the response time of said physical disks and by comparing the average value with the response time of said specific physical disk.

3. The disk array apparatus according to claim 1,
wherein said performance deterioration judging unit judges performance deterioration of said specific physical disk by calculating an average value of the response time of said physical disks other than said specific physical disk and by comparing the average value with the response time of said specific physical disk.

4. The disk array apparatus according to claim 2,
wherein said performance deterioration judging unit judges performance deterioration of said specific physical disk on the basis of a ratio of the response time of said specific physical disk to said average value.

5. The disk array apparatus according to claim 2,
wherein said performance deterioration judging unit judges performance deterioration of said specific physical disk by comparing the ratio of the response time of said specific physical disk to said average value with a deterioration reference ratio set in advance.

6. The disk array apparatus according to claim 2, further comprising:
a disk exchanging unit judging that said specific physical disk needs to be exchanged, by comparing the ratio of the response time of said specific physical disk to said average value with a deterioration reference ratio set in advance.

7. The disk array apparatus according to claim 6, further comprising:
a spare physical disk,
wherein said disk exchanging unit exchanges said specific physical disk for said spare disk, when said disk exchanging unit judges that said specific physical disk needs to be exchanged.

8. The disk array apparatus according to claim 6, further comprising:
a spare physical disk,
wherein when said disk exchanging unit judges that said specific physical disk needs to be exchanged, and when an exchange timing condition set in advance is satisfied, said disk exchanging unit exchanges said specific physical disk for said spare physical disk.

9. A disk array control method including a plurality of physical disks, comprising:
a step a) of measuring a response time to an access to said physical disk; and
a step b) of judging performance deterioration of a specific physical disk of said plurality of physical disks on the basis of the response time of said physical disks and the response time of said specific physical disk.

10. The disk array control method according to claim 9, wherein said step b) includes
calculating an average value of the response time of said physical disks; and
judging performance deterioration of said specific physical disk by comparing the average value with the response time of said specific physical disk.

11. A signal-bearing medium tangibly embodying a program of machine-readable instructions executable by a digital processing apparatus that permits a computer to function as:
a response time measuring unit measuring a response time to an access to a plurality of physical disks included in a disk array apparatus; and
a performance deterioration judging unit judging performance deterioration of a specific physical disk of said plurality of physical disks on the basis of the response time of said physical disks and the response time of said specific physical disk.

12. The signal-bearing medium tangibly embodying a program of machine-readable instructions executable by a digital processing apparatus according to claim 11,
wherein said performance deterioration judging unit judges performance deterioration of said specific physical disk by calculating an average value of the response time of said physical disks, and by comparing the average value with the response time of said specific physical disk.

13. A disk array apparatus including a plurality of physical disks, comprising:
means for measuring a response time to an access to said physical disks; and
means for judging performance deterioration of a specific physical disk of said plurality of physical disks on the basis of the response time of said physical disks and the response time of said specific physical disk.
